(19) United States
(12) Patent Application Publication
(10) Pub. No.: US 2021/0227046 A1
(43) Pub. Date: Jul. 22, 2021

(54) SERVICE DELIVERY AT THE EDGE

(71) Applicant: HUGHES NETWORK SYSTEMS, LLC, Germantown, MD (US)

(72) Inventors: Chi-Jiun SU, Rockville, MD (US); Neal BECKER, Germantown, MD (US); Lin-Nan LEE, Potomac, MD (US); Stan KAY, Germantown, MD (US)

(73) Assignee: HUGHES NETWORK SYSTEMS, LLC, Germantown, MD (US)

(21) Appl. No.: 16/749,325

(22) Filed: Jan. 22, 2020

(51) Int. Cl. H04L 29/08; H04L 12/66; H04L 12/14; H04L 12/26; H04B 7/185; G06F 9/455

(52) U.S. Cl. CPC H04L 67/32; H04L 12/66; H04L 67/141; G06F 2009/45595; H04L 43/08; H04B 7/185; G06F 9/45558; H04L 12/1403

(57) ABSTRACT

A method and system for delivering services to terminals and associated edge devices in a satellite communication system. A network node remotely creates at least one service appliance within a terminal of the satellite communication system and customer premise equipment (CPE) connected to the terminal. Containerized applications are then transmitted from the network node to the service appliance. The service appliance subsequently executes the containerized application using hardware resources of the terminal and CPE. Usage of the containerized application can also be monitored.

### BACKGROUND INFORMATION

Recent advances in virtualization technology have led to virtualization of network services that have been traditionally run on proprietary and dedicated hardware. Network Function Virtualization (NFV) is an initiative to increase the use and availability of virtualized services. With NFV, functions such as routing, load balancing, and firewalls can be packaged as virtual machines (VMs) on available hardware. NFV provides various advantages to operators and service providers, such as cost, flexibility, and agility. For example, NFV provides reduced operator capital expenditures (CAPEX) and operational expenditures (OPEX) through reductions in equipment costs and power consumption. NFV also provides reduced time-to-market to deploy new network services, improved return on investment from new service, greater flexibility to scale up, scale down or evolve service, and increased opportunities to deploy new innovative services on a trial basis.

The use of NFV has been to data centers and cloud services. Recent advances in light weight virtualization have made it possible apply virtualization techniques to service delivery systems. Such systems can be used, for example, to provide value-added services to customer over existing network connections without adversely affecting existing services. This can present a challenge to users in areas that lack broadband network services, due to the lack sufficient bandwidth. Satellite communication systems are increasingly used to provide broadband services to locations that lack ground-based infrastructure for such services. Despite its the increased availability and use in such areas, however, there have been no efforts to provide NFV or similar technology in satellite communication systems.

Based on the foregoing, there is a need for an approach for delivering virtualized services using satellite networks.

### BRIEF SUMMARY

Methods and systems are disclosed for providing service delivery at terminals and associated edge devices using containerized applications. According to an embodiment, a method includes: creating, by a network node, at least one service appliance within at least one of a terminal of a satellite communication system and customer premise equipment (CPE) connected to the terminal; transmitting a containerized application from the network node to the at least one service appliance, wherein the at least one service appliance is configured to execute the containerized application using hardware resources of the terminal and CPE; and monitoring usage of the containerized application.

According to another embodiment, a system includes: a terminal of a satellite communication system; one or more customer premise equipment (CPEs) connected to the terminal; and a network node. The network node configured to: create at least one service appliance within at least one of the terminal and the one or more CPEs, transmit a containerized application the at least one service appliance, wherein the at least one service appliance is configured to execute the containerized application using hardware resources of the terminal and one or more CPEs, and monitor usage of the containerized application.

According to another embodiment, a method includes: creating, by a network node, at least one service appliance within at least one of a terminal of a satellite communication system and customer premise equipment (CPE) connected to the terminal; receiving, at the network node, a request to provision an application for the at least one service appliance, wherein the request is received from an application server associated with the application; containerizing the application by packaging at least binary files associated with the application, software dependencies, and hardware requirements into a self-contained unit; provisioning the containerized application; and transmitting the provisioned and containerized application to the at least one service appliance, wherein the at least one service appliance is configured to execute the containerized application using hardware resources of the terminal and CPE.

The foregoing summary is only intended to provide a brief introduction to selected features that are described in greater detail below in the detailed description. As such, this summary is not intended to identify, represent, or highlight features believed to be key or essential to the claimed subject matter. Furthermore, this summary is not intended to be used as an aid in determining the scope of the claimed subject matter.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a satellite communication system capable of providing voice and data services, according to various embodiments;

FIG. 2 is a diagram of a satellite communication system capable of providing containerized service delivery to terminals, according to one embodiment;

FIG. 3 is a flowchart of a process for providing containerized service delivery to terminals, according to one embodiment;

FIG. 4 is another flowchart of a process for providing containerized service delivery to terminals, according to one embodiment;

FIG. 5 is a diagram illustrating containerized service delivery to a terminal, according to one embodiment;

FIG. 6 is a diagram of a computer system that can be used to implement various exemplary features and embodiments; and

FIG. 7 is a diagram of a chip set that can be used to implement various exemplary features and embodiments.

### DETAILED DESCRIPTION

A method and system are disclosed for delivering services to terminals and associated edge devices using containerized applications (or virtualized applications). In the following description, for purposes of explanation, numerous specific details are set forth in order to provide a thorough understanding of the disclosed embodiments. It will become apparent, however, to one skilled in the art that various embodiments may be practiced without these specific details or with an equivalent arrangement. In other instances, well-known structures and devices are shown in block diagram form in order to avoid unnecessarily obscuring the various embodiments.

Disclosed herein are methods and systems for providing service delivery at satellite terminals (or simply terminals) using containerized applications (or virtualized applications). The examples provided below illustrate service delivery at the “edge” of a satellite network, whereby containerized applications (or virtualized applications) that provide services are configured to use computing resources available at end-user devices, such as satellite terminals, and customer premise equipment (CPE) and other computing devices coupled thereto. The terms “terminals” and “satellite terminals” are used interchangeably in reference to different types of devices that may be used by a customer establish communication with a gateway via a satellite. As discussed in greater detail below, such terminals can be in the form of very small aperture terminals (VSATs), fixed terminals having different size antenna dishes (e.g., small, medium, large, etc.), transportable terminals, mobile terminals, etc.

A third-party service provider can submit services to a satellite communication system, and users connected the satellite communication system via terminals can access or purchase services via an interface accessed through the system. The service delivery system can be configured to handle provision of the services to the terminals, delivery of services in the form of containerized applications (or virtualized applications) to the terminals (and CPEs), monitoring usage of the services. Depending on the specific implementation, the service delivery system can also be configured to provide administrative function such as billing and maintenance of the containerized applications (or virtualized applications). In other words, the disclosed embodiments enable usage of computing resources at an edge of a satellite network (and in control of a service delivery system) by containerized applications (or virtualized applications) provided by third party service providers, to provide value-added services to the end-users of the satellite communication system. Examples of services can include applications, games/entertainment content, tools, or any other service that can be used by a subscriber at an end-user device (such as a terminal and/or CPE attached thereto), and configured to utilize hardware resources of the terminal/CPE.

Accordingly, the service provider can provide a service that uses computing resources at the edge of the satellite network, thereby alleviating resource consumption at the core network/internet as well as air-interface resources otherwise used to provide a service to end-users while using resources at the core network/internet. According to various embodiments, the service can include any service that avails of or mitigates a lower latency resulting from transmission via the satellite communication system. Alternatively or on addition, deploying service instances (i.e. instances of containerized applications (or virtualized applications)) at the edge of the network may be performed for any service that is not affected by the latency of the satellite network, such as video/media streaming, etc.

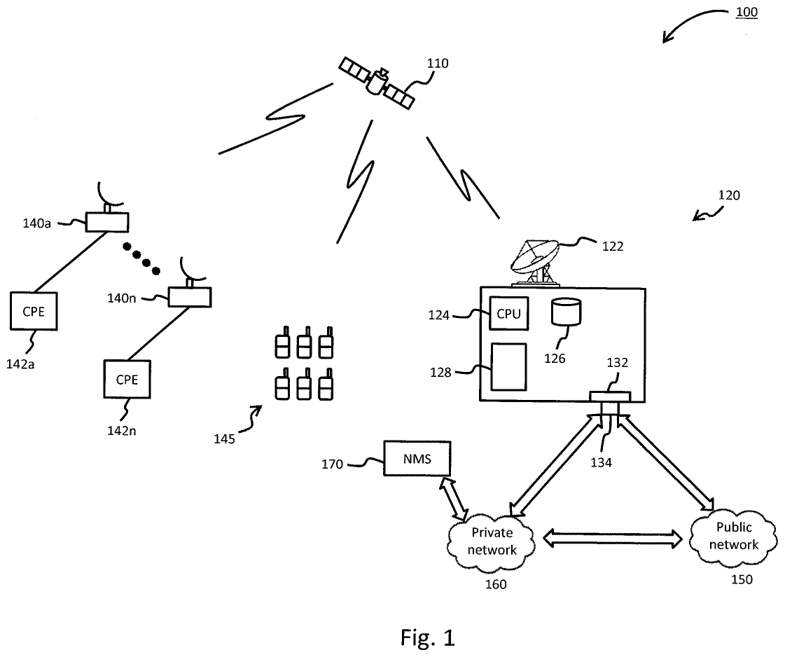

FIG. 1 illustrates a satellite communication system 100. The satellite communication system 100 includes a satellite 110 that supports communications among a number of gateways 120 (only one shown) and multiple stationary satellite terminals 140a-140n. Each satellite terminal (or terminal) 140 can be configured for relaying traffic between its customer premise equipment (CPEs) 142a-142n (i.e., user equipment), a public network 150 such as the internet, and/or its private network 160. Depending on the specific embodiment, the customer premise equipment 142 can be a desktop computer, laptop, tablet, cell phone, etc. Customer premise equipment 142 can also be in the form of connected appliances that incorporate embedded hardware resources and/or circuitry for network communication supported by the satellite terminal (or terminal) 140. Such connected appliances can include, without limitation, televisions, home assistants, thermostats, refrigerators, ovens, etc. The network of such devices is commonly referred to as the internet of things (IoT).

According to an exemplary embodiment, the satellite terminals 140 can be in the form of very small aperture terminals (VSATs) that are mounted on a structure, habitat, etc. Depending on the specific application, however, the satellite terminal 140 can incorporate an antenna dish of different sizes (e.g., small, medium, large, etc.). The satellite terminals 140 typically remain in the same location once mounted, unless otherwise removed from the mounting. According various embodiments, the satellite terminals 140 can be mounted on mobile platforms that facilitate transportation thereof from one location to another. Such mobile platforms can include, for example, cars, buses, boats, planes, etc. The satellite terminals 140 can further be in the form of transportable terminals capable of being transported from one location to another. Such transportable terminals are operational only after arriving at a particular destination, and not while being transported.

As illustrated in FIG. 1, the satellite communication system 100 can also include a plurality of mobile terminals 145 that are capable of being transported to different locations by a user. In contrast to transportable terminals, the mobile terminals 145 remain operational while users travel from one location to another. The terms user terminal, satellite terminal, mobile terminal, and terminal may be used interchangeably herein to identify any of the foregoing types. The gateway 120 can be configured to route traffic from stationary, transportable, and mobile terminals (collectively terminals 140) across the public network 150 and private network 160 as appropriate. The gateway 120 can be further configured to route traffic from the public internet 150 and private network 160 across the satellite link to the appropriate terminal 140. The terminal 140 then routes the traffic to the appropriate customer premise equipment (CPE) 142.

According to at least one embodiment, the gateway 120 can include various components, implemented in hardware, software, or a combination thereof, to facilitate communication between the terminals 140 and external networks 150, 160 via the satellite 110. According to an embodiment, the gateway 120 can include a radio frequency transceiver 122 (RFT), a processing unit 124 (or computer, CPU, etc.), and a data storage unit 126 (or storage unit). While generically illustrated, the CPU 124 can encompass various configurations including, without limitations, a personal computer, laptop, server, etc. As used herein, a transceiver corresponds to any type of antenna unit used to transmit and receive signals, a transmitter, a receiver, etc. The RFT 122 is useable to transmit and receive signals within a communication system such as the satellite communication system 100 illustrated in FIG. 1. The data storage unit 126 can be used, for example, to store and provide access to information pertaining to various operations in the satellite communication system 100. Depending on the specific implementation, the data storage unit 126 (or storage unit) can be configured as a single drive, multiple drives, an array of drives configured to operate as a single drive, etc.

According to other embodiments, the gateway 120 can include multiple processing units 124 and multiple data storage units 126 in order to accommodate the needs of a particular system implementation. Although not illustrated in FIG. 1, the gateway 120 can also include one or more workstations 125 (e.g., computers, laptops, etc.) in place of, or in addition to, the one or more processing units 124. Various embodiments further provide for redundant paths for components of the gateway 120. The redundant paths can be associated with backup components capable of being seamlessly or quickly switched in the event of a failure or critical fault of the primary component.

According to the illustrated embodiment, the gateway 120 includes baseband components 128 which operate to process signals being transmitted to, and received from, the satellite 110. For example, the baseband components 128 can incorporate one or more modulator/demodulator units, system timing equipment, switching devices, etc. The modulator/demodulator units can be used to generate carriers that are transmitted into each spot beam and to process signals received from the terminals 140. The system timing equipment can be used to distribute timing information for synchronizing transmissions from the terminals 140.

According to an embodiment, a fault management unit 130 can be included in the gateway 120 to monitor activities and output one or more alerts in the event of a malfunction in any of the gateway components. The fault management unit 130 can include, for example, one or more sensors and interfaces that connect to different components of the gateway 120. The fault management unit 130 can also be configured to output alerts based on instructions received from a remotely located network management system 170 (NMS). The NMS 170 maintains, in part, information (configuration, processing, management, etc.) for the gateway 120, and all terminals 140 and beams supported by the gateway 120. The gateway 120 can further include a network interface 132, such as one or more edge routers, for establishing connections with a terrestrial connection point 134 from a service provider. Depending on the specific implementation, however, multiple terrestrial connection points 134 may be utilized.

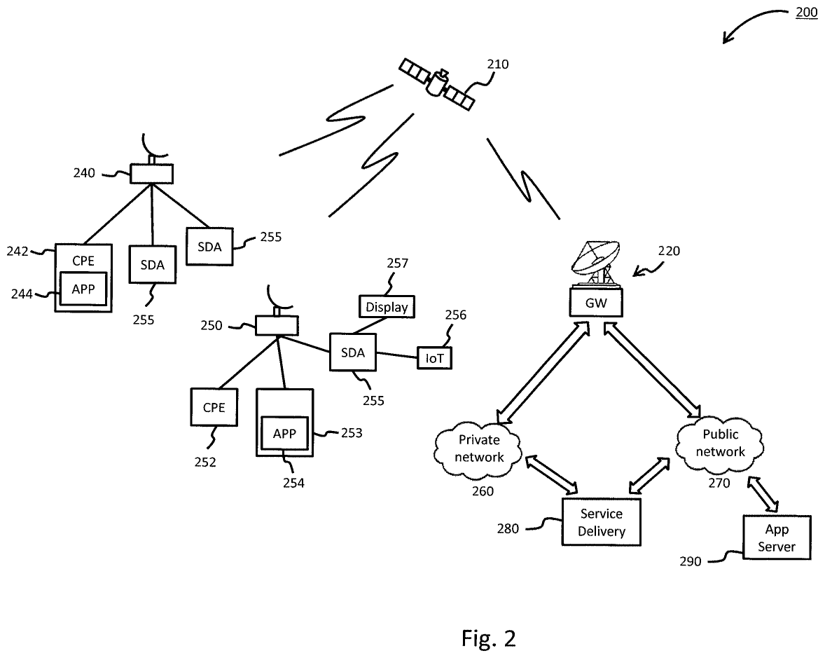

FIG. 2 is a diagram of a satellite communication system 200 capable of providing containerized service delivery to satellite terminals, according to one embodiment. Similar to satellite communication system 100, satellite communication system 200 includes a satellite 210, gateway 220, terminals 240 and 250, public network 260, and private network 270. Further, while terminal 240 is communicatively coupled to a single customer premise equipment (CPE) 242, terminal 250 is communicatively coupled to CPEs, namely CPE 252 and CPE 253. CPEs 242, 252, and 253 can include hardware resources such as an ARM single board computer (SBC), such as a Raspberry Pi®, or any other standalone device, including but not limited to a Wi-Fi router, an IoT hub or a voice assistant device. In addition, system 200 includes a service delivery system 280, and an application server 290. Thus, according to various embodiments, system 200 can be configured to receive a request to setup a service from a service provider (which may own/operate application server 290). One or more service appliances 244, 254 (or simply “appliances”) can subsequently be created on one or more of CPE 242 and CPE 253 using information transmitted via gateway 220 and satellite 210. On or more containerized applications (or virtualized applications) can be deployed for providing services to CPE 242 and/or CPE 253. Additionally, the system can monitor usage of the containerized applications (or virtualized applications), including monitoring usage by the containerized application of hardware resources associated with each terminal 240, 250, as well as air interface resources of the satellite connection between terminals 240, 250 and gateway 220.

According to at least one embodiment, the service delivery appliances 244, 254 can include virtual computing systems with sufficient computing resources to support applications in a virtualized environment. The service delivery appliances (also referred to as “virtual appliances” or simply “appliances) can be a subset of software appliances, and include virtual machine images designed to run on a specific virtualization platform. This can be accomplished, for example, by installing a software appliance to a virtual machine and packaging that into an image creates a virtual appliance. Thus, in an exemplary embodiment, the service delivery appliances 244, 254 can be configured to operate under the control of a service delivery provider, i.e. the entity controlling service delivery system 280. For example, computing devices such as CPE 242, 243 can usually be under the control of the satellite service provider, whereas computing devices 253 (such as, for example, routers, hubs and voice assistant devices) can be under the control of device owner. Meanwhile, with the appropriate permissions, certain hardware resources of CPE 253 can be controlled by a service provider or satellite provider. For example, the hardware resources associated with the terminal 240, 250 can include any of CPE 242, 252, 253, or any other computing device communicatively coupled to the terminal. Further, the appliances can be configured to host or execute services in the form of containerized applications (which can be created/containerized by the service provider or the satellite provider via service delivery system 280). Application containerization is an OS-level virtualization method used to deploy and run distributed applications without launching an entire virtual machine (VM) for each application. Multiple isolated applications or services can run on a single host and access the same OS kernel. Application containers include all runtime components (e.g., as files, environment variables, libraries, etc.) necessary to run the desired software. Application containers consume fewer resources than a comparable deployment on virtual machines because containers share resources without a full operating system to underpin each app. The complete set of information to execute in a container is the image. The container engine deploys these images on hosts, such as terminals/CPEs.

Thus, in an exemplary embodiment, CPE 242, 252 and/or 253 can be configured to display a user interface enabling a user of the terminals 240, 250 to submit a service request via satellite 210 to the service delivery system 280. According to an embodiment, a service store portal hosted by service delivery system 280 and presented to the user. In response to receiving the service request, the service delivery system 280 would transmit the containerized application to the terminals 240, 250 via satellite 210, such that the containerized applications (or virtualized applications) are executed using appliances 244, 254 and hardware resources of CPE 242, 252 and 253. Further, monitoring the hardware resources can include determining whether or not the hardware resources of CPE 242, 252 and 253 are sufficient for the usage of the containerized applications (or virtualized applications). Any bandwidth dedicated towards usage of the containerized application can be allocated between gateway 220, satellite 210, and terminals 240, 250. For example, the services provided by the containerized application can be prioritized or assigned a normal priority consistent with similar processes on the CPE 242, 252, and 253. Further, monitoring the usage can include determining media consumption by the terminal, particularly in the case that the service (or containerized application associated therewith) includes a media viewing or listening service. In these cases, monitoring usage of the service can be used to bill a user for consumption of media resources, as well as to predict future usage and allocate resources accordingly.

Although only one service delivery system 280 and application server 290 are illustrated in FIG. 2, any number of these components may be present in different systems. For example, deploying multiple service delivery systems, or service delivery managers within a service delivery system can provide increased capabilities to deploy and monitor appliances and application containers at any number of terminals 240, 250 and/or associated CPEs 242, 252, 253. Multiple service delivery managers can provide redundancy and ensure recovery from the failure of a manager node without downtime. Generally, the multiple service delivery managers can be responsible for: a) Set up the service delivery system which is ready to be joined by service delivery appliances, b) Act as virtual network function (VNF) orchestrator to orchestrate a VNF for value-added services provided by application servers (such as application server 290), c) Perform Operation, Administration and Management (OAM) of value-added service VNFs, d) Remove VNFs when a user of a terminal 240, 250, etc. cancels their subscription to the value-added service, and e) Receive value-added service applications or virtualized value-added service applications from value-added service providers, i.e. operators of application server 290.

Further, a communication session between the service delivery system 280 and the appliance 244, 254 using the satellite communication network can include the service delivery system 280 listening to a TCP or UDP port on the terminal 240, 250 and/or CPE 242, 252, 253, and one or more appliances 244, 254 connecting to the server port with a permission credential, such that an encrypted communication connection is set up between an appliance and a service deliver manager of the service delivery system 280.

According to one or more embodiments, the satellite communication system 200 can also include multiple service delivery appliances (SDA) 255 connected to the terminals 240, 250. The SDA 255 can be in the form of a Raspberry Pi SBC, or any appropriate device, capable of utilizing a lightweight virtualization software. The SDA 255 may connect to the terminal 240, 250 in order to access external networks via the satellite link. While FIG. 2 illustrates the SDA being connected to the terminal 240, 250, it should be noted that any appropriate network connection may be utilized. For example, internet access through terrestrial internet service providers (ISP) may be utilized by the SDA 255 in order to establish a network connection.

Furthermore, the SDA 255 may utilize mobile/cellular networks in a variety of manners. Cellular service providers often carry handsets which support a “hotspot” mode wherein the handset facilitates internet access (via the cellular network) to multiple user devices, such as tablets, laptops, other cellular handsets, etc. (in other words, CPEs 242, 252). The SDA 255 can therefore access such a hotspot to establish an internet connection using the cellular network. Cellular service providers also carry dedicated hotspot devices capable of facilitating internet access to other user devices such as CPEs 242, 252. The dedicated hotspot devices provide internet access using the cellular network in a manner similar to the handsets. Unlike the handsets, however, the dedicated hotspots lack direct voice capabilities. Accordingly, the SDA 255 may utilize any device supported by the cellular service provider to access the internet.

According to various embodiments, the terminal 240, 250 may incorporate an internal cellular-based modem in order to provide internet access to devices without having to route network traffic through the satellite 210. For example, terminal 240, 250 may include an internal long term evolution (LTE) modem (or successor technology standard) in order to provide wireless (i.e., Wi-Fi) connectivity to the CPEs via a cellular network. It should be noted that the foregoing examples are intended to be illustrative, and not exhaustive. Rather, any type of internet connection can be used to connect the SDA 255 and/or CPEs 242, 252 to the service store or subscribed services.

The SDA 255 may further implement value added services such as IoT service to allow control of IoT devices 256 such as smart plugs, Wi-Fi thermostats, etc. According to such embodiments, the service delivery system 280 can deploy virtualized services in the SDA 255 and remove such services as needed. Furthermore, the SDA 255 may connect to an online service store for reviewing and/or selecting different services. Depending on the specific system implementation, the online service store may be accessible using any internet capable device (e.g., laptop, tablet, phone, etc.). Specific applications may be available from the service store for installation on mobile platforms. The online store may therefore be accessed from any location to browse and select different services. Upon selecting a service, delivery may be initiated to the SDA 255. Alternatively, upon selecting a service, content may be accessed using multiple platforms over the internet. According to further embodiments, the SDA 255 may implement content delivery services which require a display 257.

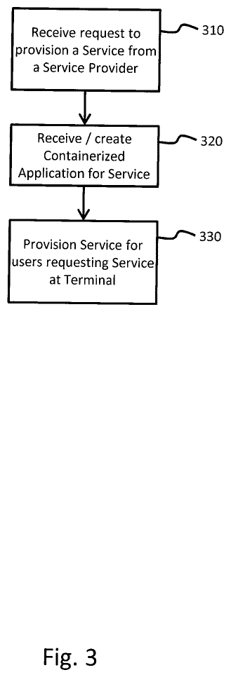

FIG. 3 is a flowchart of a process for providing containerized service delivery to terminals, according to one embodiment. The process of FIG. 3 may be implemented by any network node such as those described in FIG. 2, including but not limited to service delivery system 280 and/or application server 290. Although FIG. 3 depicts steps performed in a particular order for purposes of illustration and discussion, the operations discussed herein are not limited to any particular order or arrangement. One skilled in the art, using the disclosures provided herein, will appreciate that various steps of the process can be omitted, rearranged, combined, and/or adapted in various ways.

At 310, a request to provision a service is received from a service provider. The service provider can be any entity that provides a service that may be used by a subscriber, such as a subscriber to the satellite network. The service provider can contract with the satellite provider to supply value-added services to the subscribers of the satellite network. As previously discussed, such services can include, without limitation, applications, games/entertainment content, tools, etc. Furthermore, such value-added services can include any other service that can be used by a subscriber at an end-user device (i.e., CPE), and configured to utilize hardware resources of the CPE. The service provider can therefore provide services that use computing resources at the edge of the satellite network, thereby reducing resource consumption at the core network/internet as well as air-interface resources otherwise used to provide a service to end-users. According to an embodiment, the request to provision the service may be received from a network node/server associated with the service provider, such as application server 290 or any other network node. According to other embodiments, the request may be received at a network node associated with the satellite provider, such as a service delivery system 280 and/or a service deliver manager coupled thereto.

At 320, a containerized application is created by, or received from, the service provider. As previously discussed, containerization is an OS-level virtualization method used to deploy and run distributed applications without launching an entire virtual machine (VM) for each application. Multiple isolated applications or services can run on a single host and access the same OS kernel. Application containers include runtime components such as files, environment variables, libraries, etc. necessary to run the desired software. Application containers consume fewer resources than a comparable deployment on virtual machines because containers share resources without a full operating system to underpin each app. The complete set of information to execute in a container is the image. The container engine deploys these images on hosts, such as terminals/CPEs. In one exemplary embodiment, a service in the form of an application can containerized by the service provider prior to being submitted to the service delivery system. In another embodiment, the application can received by the service delivery system and then containerized at the service delivery system.

At 330, the service is provisioned for users requesting the service via a terminal. For example, the value-added services can be offered to the users via a service store configured by the service delivery system. The service store can be a digital platform developed and maintained by the service delivery system for value-added services deployable at computing resources in the service delivery system. The store allows customers in the service delivery system to browse and subscribe the services. Users who subscribe to the service can optionally be billed by the service delivery system. For example, if the service delivery system is operated by a satellite provider, the bill for value-added services can be a part of the monthly bill for the satellite service. In an exemplary embodiment, the CPE can be configured to display a user interface enabling a user to submit a service request (via the satellite network) to the service delivery system. In response to receiving the service request, the service delivery system can be configured to transmit the containerized application to the terminals via the satellite connection. The containerized applications (or virtualized applications) can subsequently be executed using the appliances and hardware resources of the CPE. Further, usage of the applications can be monitored, for example, via a bearer or other direct connection between the terminal and the satellite delivery system and/or the application server. Hardware resources can be monitored, for example, by determining whether or not the hardware resources of the CPE are sufficient for the usage of the containerized applications (or virtualized applications). Bandwidth dedicated towards usage of the containerized application can be allocated between the core satellite network (e.g. a gateway, satellite, and terminals), and services provided by the containerized application can be prioritized or resources allocated as normal.

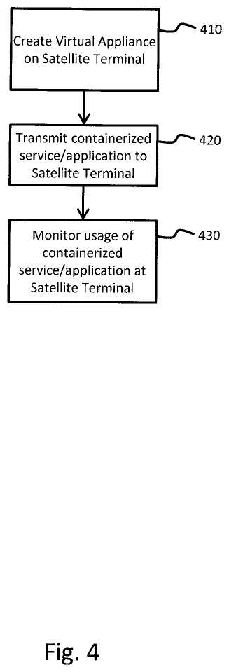

FIG. 4 is a flowchart of a process for providing containerized service delivery to terminals, according to one embodiment. The process of FIG. 4 may be implemented by any network node such as those described in FIG. 2, including but not limited to service delivery system 280 and/or application server 290. Although FIG. 4 depicts steps performed in a particular order for purposes of illustration and discussion, the operations discussed herein are not limited to any particular order or arrangement. One skilled in the art, using the disclosures provided herein, will appreciate that various steps of the process can be omitted, rearranged, combined, and/or adapted in various ways.

At 410, a virtual appliance is created on a terminal. The terminal may be part of a satellite communication system, similar to satellite communication system 200. As previously discussed, terminal includes hardware resources that can be configured to function as a host for the virtual appliance. Various types of CPEs can also include hardware resources that can be configured to function as a host for the virtual appliance.

For example, each terminal can be communicatively coupled to one or more CPEs such as a Raspberry Pi®, router (wired, wireless, or both), network switch, an IoT hub, a voice assistant device, etc. Each CPE can include hardware resources such as an ARM single board computer (SBC), a communication interface, storage device, etc. Further, the appliance includes a virtual computing system with sufficient computing resources to support applications in a light virtualized environment. The appliances are under the control of a service delivery provider and, with the appropriate permissions, the hardware resources can be controlled by a service provider and/or satellite provider.

At 420, the containerized application/service is transmitted to the terminal. As previously discussed, the appliances are configured to host or execute services in the form of containerized applications (or virtualized applications) created or containerized by the service provider or the satellite provider. According to at least one embodiment, the container engine deploys images that include the complete set of information to execute in a container on hosts, such as terminals and/or CPEs. The terminal or CPE can be configured to display a user interface enabling submission of a service request to the service delivery system. The service delivery system subsequently transmits the containerized application to the terminal for execution using the appliances and hardware resources of the terminal and/or CPE.

At 430, usage of the service on the terminal (and/or hardware resources thereof) is monitored. The monitoring can include determining whether or not the hardware resources of the CPE and/or terminal are sufficient for the usage of the containerized applications (or virtualized applications). Further, bandwidth usage can be monitored by the terminal or gateway, and services provided by the containerized application can be prioritized or resources allocated as normal. The monitoring can further include OAM of value-added services, removal of VNFs when a user cancels their subscription to the value-added service, billing for usage, reporting the usage, etc. Multiple service delivery managers within a service delivery system can provide increased capabilities to deploy and monitor appliances and application containers at any number of terminals, while also providing redundancy to ensure recovery from the failure of a manager node without downtime. Further, the service delivery manager can be coupled with an OAM module which monitors the health of the service instance, communication status, resource usages and etc. Upon failure of the service instance, the OAM module collects a log, reports it to the application server, and restarts the instance of the containerized application. The OAM module also manages the computing resource in a service delivery appliance which is shared among service instances deployed. It limits the number of service instances in a service delivery appliance to achieve good QoS of each service. The OAM module can report issues and status of service instances to the service provider.

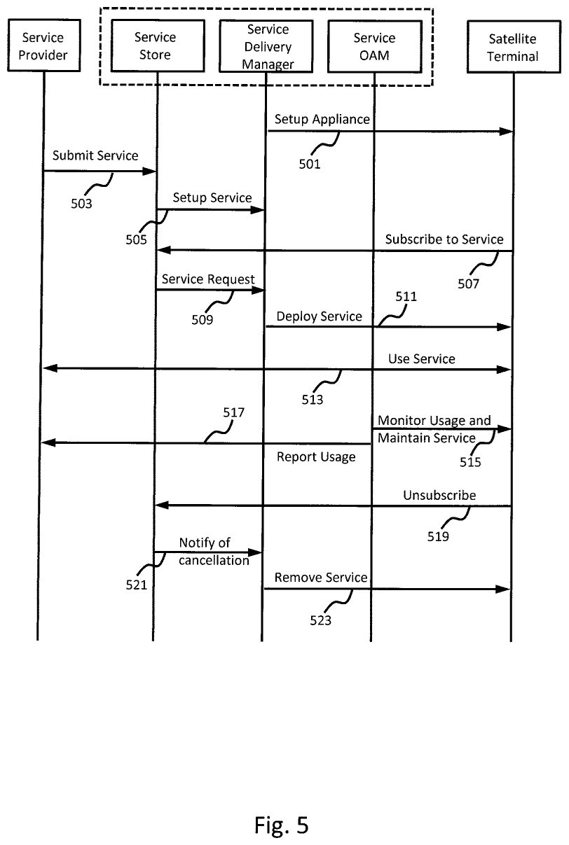

FIG. 5 is a diagram illustrating a process for containerized service delivery to a terminal, according to various embodiments. The process of FIG. 5 may be implemented by any network node such as those described in FIG. 2, including but not limited to service delivery system 280, application server 290, terminals 240, 250, etc. At 501, a virtual appliance is created on a terminal. The virtual appliance is created by a service delivery manager that is part of a service delivery system. The terminal may be part of a satellite communication system, similar to satellite communication system 200. Each terminal includes hardware resources that can be configured as a host for the virtual appliance.

At 503, a request to provision a service is received from a service provider. The service provider can be any entity that provides a service that may be used by a subscriber, such as a subscriber to the satellite network. The service provider can contract with the satellite provider to provide value-added services to the subscribers of the satellite network. Examples of services can include applications, games/entertainment content, tools, or any other service that can be used by a subscriber via a CPE. The request to provision the service may be received from a network node/server associated with the service provider at a service store associated with the service delivery system. At 505, the service store communicates with the service delivery manager to set up the service. Depending on the specific implementation, this may include setting up billing for the service, containerizing an application configured to provide the service, and/or setting up the service on the service store as an option which can be selected for subscription. As previously discussed, a service in the form of an application can be containerized by the service provider prior to being submitted to the service delivery system. The application can also be received by the service delivery system and then containerized at the service delivery system.

At 507, a subscription request is received from the terminal. For example, the value-added services can be offered to the users via a service store configured by the service delivery system. The service store can be a digital platform developed and maintained by the service delivery system for value-added services deployable at computing resources in the service delivery system. The store allows customers in the service delivery system to browse and subscribe the services. The service request is forwarded, at 509, to the service delivery manager. At 511, the service delivery manager deploys, or transmits, the containerized application to the terminal.

Subsequently, at 513, the containerized applications (or virtualized applications) are executed using the appliances and hardware resources of the CPE and/or terminal. For example, a user uses the service through the application server associated with the service provider, which communicates with the service instance (i.e. containerized application) running in the service delivery appliance on the hardware resource of the terminal. In one exemplary embodiment, the containerized application can be used directly from the service instance at the terminal and/or CPE. Further, the containerized application can include a user interface that communicates with the application server. At 515, application usage can be monitored, for example, via a bearer or other direct connection between the terminal and the satellite delivery system and/or the application server. Hardware resources can to determine overall usage, and whether or not the hardware resources of the CPE and/or terminal are sufficient for the usage of the containerized applications (or virtualized applications). Bandwidth dedicated towards usage of the containerized application can be allocated between the core satellite network (e.g. a gateway, satellite, and terminals), and services provided by the containerized application can be prioritized or resources allocated as normal. At 517, usage of the service is reported to the service provide. According to an embodiment, usage reports can be generated and transmitted to the service provider at predetermined intervals (e.g., hourly, daily, weekly, monthly, etc.).

Depending on the specific service features, users may eventually discontinue the service subscription. Accordingly, at 519, an unsub scribe request is received from the terminal. For example, a user may access a user interface to access their account and unsubscribe from the service via the service store. If the service is configured to generate a separate interface (e.g., a graphical user interface) on CPE, the user may unsubscribe directly from the service. At 521, the service delivery manager is notified of the removal/cancellation received from the user. The service delivery manager removes the service instance at 523 by communicating with the service delivery appliance on the terminal, and may also notify the service provider about the cancellation of the service by the user.

Various features described herein may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. For example, such hardware/software/firmware combinations can be incorporated into the previously described service delivery system, application server, receivers, transmitters, transceivers, gateway, etc. Additionally, such hardware can be interfaced to connect and/or facilitate communication between different components such as the terminal and CPEs, gateway and service delivery system, etc. Furthermore, various features can be implemented using algorithms illustrated in the form of flowcharts and accompanying descriptions. Some or all steps associated with such flowcharts can be performed in a sequence independent manner, unless otherwise indicated. Those skilled in the art will also understand that features described in connection with one figure can be combined with features described in connection with another figure. Such descriptions are only omitted for purposes of avoiding repetitive description of every possible combination of features that can result from the disclosure.

The terms software, computer software, computer program, program code, and application program may be used interchangeably and are generally intended to include any sequence of machine or human recognizable instructions intended to program/configure a computer, processor, server, etc. to perform one or more functions. Such software can be rendered in any appropriate programming language or environment including, without limitation: C, C++, C#, Python, R, Fortran, COBOL, assembly language, markup languages (e.g., HTML, SGML, XML, VoXML), Java, JavaScript, etc. As used herein, the terms processor, microprocessor, digital processor, and CPU are meant generally to include all types of processing devices including, without limitation, single/multi-core microprocessors, digital signal processors (DSPs), reduced instruction set computers (RISC), general-purpose (CISC) processors, gate arrays (e.g., FPGAs), PLDs, reconfigurable compute fabrics (RCFs), array processors, secure microprocessors, and application-specific integrated circuits (ASICs). Such digital processors may be contained on a single unitary IC die, or distributed across multiple components. Such exemplary hardware for implementing the described features are detailed below.

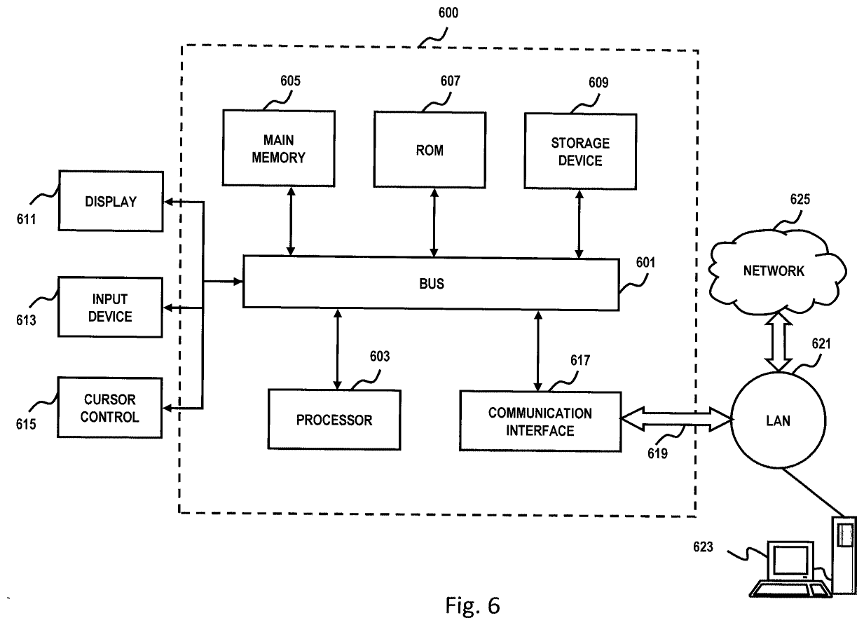

FIG. 6 is a diagram of a computer system that can be used to implement features of various embodiments. The computer system 600 includes a bus 601 or other communication mechanism for communicating information and a processor 603 coupled to the bus 601 for processing information. The computer system 600 also includes main memory 605, such as a random access memory (RAM), dynamic random access memory (DRAM), synchronous dynamic random access memory (SDRAM), double data rate synchronous dynamic random-access memory (DDR SDRAM), DDR2 SDRAM, DDR3 SDRAM, DDR4 SDRAM, etc., or other dynamic storage device (e.g., flash RAM), coupled to the bus 601 for storing information and instructions to be executed by the processor 603. Main memory 605 can also be used for storing temporary variables or other intermediate information during execution of instructions by the processor 603. The computer system 600 may further include a read only memory (ROM) 607 or other static storage device coupled to the bus 601 for storing static information and instructions for the processor 603. A storage device 609, such as a magnetic disk or optical disk, is coupled to the bus 601 for persistently storing information and instructions.

The computer system 600 may be coupled via the bus 601 to a display 611, such as a light emitting diode (LED) or other flat panel displays, for displaying information to a computer user. An input device 613, such as a keyboard including alphanumeric and other keys, is coupled to the bus 601 for communicating information and command selections to the processor 603. Another type of user input device is a cursor control 615, such as a mouse, a trackball, or cursor direction keys, for communicating direction information and command selections to the processor 603 and for controlling cursor movement on the display 611. Additionally, the display 611 can be touch enabled (i.e., capacitive or resistive) in order facilitate user input via touch or gestures.

According to an exemplary embodiment, the processes described herein are performed by the computer system 600, in response to the processor 603 executing an arrangement of instructions contained in main memory 605. Such instructions can be read into main memory 605 from another computer-readable medium, such as the storage device 609. Execution of the arrangement of instructions contained in main memory 605 causes the processor 603 to perform the process steps described herein. One or more processors in a multi-processing arrangement may also be employed to execute the instructions contained in main memory 605. In alternative embodiments, hard-wired circuitry may be used in place of or in combination with software instructions to implement exemplary embodiments. Thus, exemplary embodiments are not limited to any specific combination of hardware circuitry and software.

The computer system 600 also includes a communication interface 617 coupled to bus 601. The communication interface 617 provides a two-way data communication coupling to a network link 619 connected to a local network 621. For example, the communication interface 617 may be a digital subscriber line (DSL) card or modem, an integrated services digital network (ISDN) card, a cable modem, fiber optic service (FiOS) line, or any other communication interface to provide a data communication connection to a corresponding type of communication line. As another example, communication interface 617 may be a local area network (LAN) card (e.g. for Ethernet™ or an Asynchronous Transfer Mode (ATM) network) to provide a data communication connection to a compatible LAN. Wireless links can also be implemented. In any such implementation, communication interface 617 sends and receives electrical, electromagnetic, or optical signals that carry digital data streams representing various types of information. Further, the communication interface 617 can include peripheral interface devices, such as a Universal Serial Bus (USB) interface, a High Definition Multimedia Interface (HDMI), etc. Although a single communication interface 617 is depicted in FIG. 6, multiple communication interfaces can also be employed.

The network link 619 typically provides data communication through one or more networks to other data devices. For example, the network link 619 may provide a connection through local network 621 to a host computer 623, which has connectivity to a network 625 such as a wide area network (WAN) or the Internet. The local network 621 and the network 625 both use electrical, electromagnetic, or optical signals to convey information and instructions. The signals through the various networks and the signals on the network link 619 and through the communication interface 617, which communicate digital data with the computer system 600, are exemplary forms of carrier waves bearing the information and instructions.

The computer system 600 can send messages and receive data, including program code, through the network(s), the network link 619, and the communication interface 617. In the Internet example, a server (not shown) might transmit requested code belonging to an application program for implementing an exemplary embodiment through the network 625, the local network 621 and the communication interface 617. The processor 603 may execute the transmitted code while being received and/or store the code in the storage device 609, or other non-volatile storage for later execution. In this manner, the computer system 600 may obtain application code in the form of a carrier wave.

The term “computer-readable medium” as used herein refers to any medium that participates in providing instructions to the processor 603 for execution. Such a medium may take many forms, including but not limited to non-volatile media, volatile media, and transmission media. Non-volatile media include, for example, optical or magnetic disks, such as the storage device 609. Non-volatile media can further include flash drives, USB drives, microSD cards, etc. Volatile media include dynamic memory, such as main memory 605. Transmission media include coaxial cables, copper wire and fiber optics, including the wires that comprise the bus 601. Transmission media can also take the form of acoustic, optical, or electromagnetic waves, such as those generated during radio frequency (RF) and infrared (IR) data communications. Common forms of computer-readable media include, for example, a USB drive, microSD card, hard disk drive, solid state drive, optical disk (e.g., DVD, DVD RW, Blu-ray), or any other medium from which a computer can read.

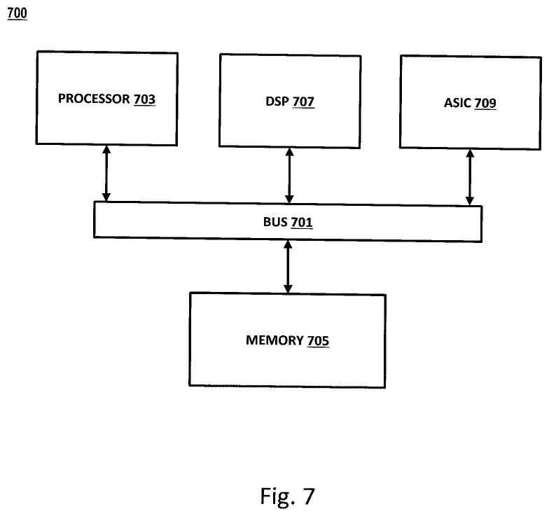

FIG. 7 illustrates a chip set 700 upon which features of various embodiments may be implemented. Chip set 700 is programmed to implement various features as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 700, or a portion thereof, constitutes a means for performing one or more steps of the figures.

In one embodiment, the chip set 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 703 and accompanying components have connectivity to the memory 705 via the bus 701. The memory 705 includes both dynamic memory (e.g., RAM, magnetic disk, re-writable optical disk, etc.) and static memory (e.g., ROM, CD-ROM, DVD, BLU-RAY disk, etc.) for storing executable instructions that when executed perform the inventive steps described herein. The memory 705 also stores the data associated with or generated by the execution of the inventive steps.

While certain exemplary embodiments and implementations have been described herein, other embodiments and modifications will be apparent from this description. Accordingly, the various embodiments described are not intended to be limiting, but rather are encompassed by the broader scope of the presented claims and various obvious modifications and equivalent arrangements.

1. A method, comprising:
receiving a request, from a network node, to supply one or more services via a satellite communication system;
creating, by the network node, at least one service appliance within at least one of a terminal of the satellite communication system and customer premise equipment (CPE) connected to the terminal, wherein the at least one service appliance is used to provide the one or more services;
transmitting a containerized application from the network node to the at least one service appliance via the satellite communication system, wherein the at least one service appliance is configured to execute the containerized application using hardware resources of the terminal and CPE; and
monitoring usage of air interface resources of the satellite communication system by the containerized application.

2. The method of claim 1, further comprising initiating a communication session between the network node and the at least one service appliance via the satellite communication system.

3. The method of claim 2, wherein the network node is communicatively coupled to the gateway via a public network, a private network, or both.

4. The method of claim 3, further comprising:
receiving an application from an application server communicatively coupled to the network node; and
containerizing the application into the containerized application.

5. The method of claim 1, further comprising:
receiving a request for a service at the network node from the at least one service appliance; and
transmitting the containerized application from the network node to the at least one service appliance in response to the request.

6. The method of claim 5, further comprising:
generating an interface, by the at least one service appliance, for selecting at least one service available from the network node,
wherein the request is made via the interface.

7. The method of claim 1, wherein the monitoring further comprises monitoring hardware usage by the containerized application, network usage by the containerized application, or both.

8. The method of claim 1, wherein the monitoring further comprises determining whether or not sufficient hardware resources are available for use by the containerized application.

9. The method of claim 1, further comprising billing a user based on the monitored usage of the containerized application, by an operator of the satellite communication system.

10. A system comprising:
a terminal of a satellite communication system;
one or more customer premise equipment (CPEs) connected to the terminal; and
a network node configured to:
transmit a request to supply one or more services via the satellite communication system,
create at least one service appliance within at least one of the terminal and the one or more CPEs, wherein the at least one service appliance is used to provide the one or more services, and
transmit a containerized application to the at least one service appliance via the satellite communication system, wherein the at least one service appliance is configured to execute the containerized application using hardware resources of the terminal and one or more CPEs,
wherein the terminal is configured to monitor usage of air interface resources of the satellite communication system by the containerized application.

11. The system of claim 10, wherein the network node is further configured to initiate a communication session with the at least one service appliance via a gateway of the satellite communication system.

12. The system of claim 11, wherein the network node is configured to establish a communication link with the gateway via a public network, a private network, or both.

13. The system of claim 10, wherein the network node is further configured to:
receiving an application from an application server communicatively coupled to the network node; and
containerizing the application into the containerized application.

14. The system of claim 10, wherein the network node is further configured to:
receive a request for a service from the at least one service appliance; and
transmit the containerized application from to the at least one service appliance in response to the request.

15. The system of claim 14, wherein the at least one service appliance is configured to:
generate an interface for selecting at least one service available from the network node; and
facilitate the request for the service through the interface.

16. The system of claim 10, wherein the network node is further configured to monitor hardware usage by the containerized application, network usage by the containerized application, or both.

17. The system of claim 10, wherein the network node is further configured to determining whether or not sufficient hardware resources are available for use by the containerized application.

18. The system of claim 10, further comprising billing a user based on the monitored usage of the containerized application, by an operator of the satellite communication system.

19. A method, comprising:
receiving a request, from a network node, to supply one or more services via a satellite communication system;
creating, by the network node, at least one service appliance within at least one of a terminal of the satellite communication system and customer premise equipment (CPE) connected to the terminal, wherein the at least one service appliance is used to provide the one or more services;
receiving, at the network node, a request to provision an application for the at least one service appliance, wherein the request is received from an application server associated with the application;
containerizing the application by packaging at least binary files associated with the application, software dependencies, and hardware requirements into a self-contained unit;
provisioning the containerized application;
transmitting the provisioned and containerized application to the at least one service appliance, wherein the at least one service appliance is configured to execute the containerized application using hardware resources of the terminal and CPE; and
monitoring the containerized application's usage of air interface resources of the satellite communication system.
